(19) United States
(12) Patent Application Publication
(10) Pub. No.: US 2018/0355291 A1
(43) Pub. Date: Dec. 13, 2018

(54) AQUEOUS SOLUTION CONTAINING A COMPLEXING AGENT IN HIGH CONCENTRATIONS

(71) Applicant: BASF SE, Ludwigshafen am Rhein (DE)

(72) Inventors: Marta REINOSO GARCIA, Ludwigshafen (DE); Nathalie Sophie LETZELTER, Cincinnati, OH (US); Frank HUELSKOETTER, Cincinnati, OH (US); Rohan Govind MURKUNDE, Cincinnati, OH (US); Kevin George GOODAL, Cincinnati, OH (US)

(73) Assignee: BASF SE, Ludwigshafen am Rhein (DE)

(21) Appl. No.: 16/060,049

(22) PCT Filed: Nov. 30, 2016
(86) PCT No.: PCT/EP2016/079179

§ 371 Date: Jun. 7, 2018

(30) Foreign Application Priority Data
Dec. 8, 2015 (EP) 15198450.7

(51) Int. Cl. C11D 7/32; C11D 7/26

(52) U.S. Cl. CPC C11D 7/3245; C11D 7/265

(57) ABSTRACT

The present invention is directed towards an aqueous solution comprising (i) in the range of from 45 percent by weight to 60 percent by weight based on the total weight of the solution of at least one complexing agent (A), selected from the group consisting of methylglycine diacetic acid and its respective mono-, di-, or trialkali metal and mono-, di-or triammonium salts, and glutamic acid diacetic acid, and its respective mono-, di-, tri-or tetraalkali metal and mono-, di-, tri-or tetraammonium salts, (ii) in the range of from 1 percent by weight to 30 percent by weight based on the weight of component (A) of at least one homo-or copolymer of (meth)acrylic acid (B) that is either partially or fully neutralized, and (iii) water, said aqueous solution being stable for at least one week.

The present invention is directed towards an aqueous solution comprising

(i) in the range of from 45 percent by weight to 60 percent by weight based on the total weight of the solution of at least one complexing agent (A), selected from the group consisting of methylglycine diacetic acid and its respective mono-, di-, or trialkali metal and mono-, di- or triammonium salts, and glutamic acid diacetic acid, and its respective mono-, di-, tri- or tetraalkali metal and mono-, di-, tri- or tetraammonium salts,

(ii) in the range of from 1 percent by weight to 30 percent by weight based on the weight of component (A) of at least one homo- or copolymer of (meth)acrylic acid (B) that is either partially or fully neutralized, and

(iii) water,

said aqueous solution being stable for at least one week.

Complexing agents such as methyl glycine diacetic acid (MGDA) and glutamic acid diacetic acid (GLDA) and their respective alkali metal salts are useful sequestrants for alkaline earth metal ions such as Ca²⁺ and Mg²⁺. For that reason, they are recommended and used for various purposes such as laundry detergents and for automatic dishwashing (ADW) formulations, in particular for so-called phosphate-free laundry detergents and phosphate-free ADW formulations. For shipping such complexing agents, in most cases either solids such as granules are being applied or aqueous solutions.

Many industrial users wish to obtain complexing agents in aqueous solutions that are as highly concentrated as possible. The lower the concentration of the requested complexing agent the more water is being shipped. Said water adds to the costs of transportation, and it has to be removed later. Although about 40% by weight solutions of MGDA and even 47% by weight solutions of GLDA can be made and stored at room temperature, local or temporarily colder solutions may lead to precipitation of the respective complexing agent, as well as nucleating by impurities. Said precipitations may lead to incrustations in pipes and containers, and/or to impurities or inhomogeneity during formulation.

Granules and powders are useful because the amount of water shipped can be neglected but for most mixing and formulation processes an extra dissolution step is required.

Additives that may enhance the solubility of the respective complexing agents may be considered but such additives should not negatively affect the properties of the respective complexing agent.

WO2014/184280 discloses phosphate-free machine dishwash detergent compositions comprising 15 to 70% by weight of at least one of MGDA, GLDA and imino disuccinic acid (IDS) in combination with 0.1 to 15% by weight of a nonionic surfactant and at least on bleaching agent or enzyme.

WO 2014/191199 discloses an aqueous solution free from surfactants comprising in the range of 30 to 60% by weight of a complexing agent selected from alkali metal salts of MGDA and alkali metal salts of GLDA, and in the range of 1 to 25% by weight of at least one salt of a sulfonic or of an organic acid.

WO 2014/191198 discloses an aqueous solution free from surfactants comprising in the range of 30 to 60% by weight of a complexing agent selected from alkali metal salts of MGDA and alkali metal salts of GLDA, and a polyamines substituted with CH₂COOH groups.

It was therefore the objective of the present invention to provide highly concentrated aqueous solutions of complexing agents such as MGDA or GLDA that are stable at temperatures in the range from zero to 50° C. It was further an objective of the present invention to provide an efficient method for manufacture of highly concentrated aqueous solutions of complexing agents such as MGDA or GLDA that are stable at temperatures in the range from zero to 50° C. Neither such method nor such aqueous solution should require the use of additives that negatively affect the properties of the respective complexing agent. It was further an objective of the present invention to use the highly concentrated aqueous solutions for manufacture of cleaner compositions for industrial or institutional applications.

Accordingly, the aqueous solutions defined at the outset have been found, hereinafter also being referred to as aqueous solutions according to the invention.

Aqueous solution according to the present invention comprising

(i) in the range of from 45 percent by weight to 60 percent by weight based on the total weight of the solution of at least one complexing agent (A), selected from the group consisting of methylglycine diacetic acid and its respective mono-, di-, or trialkali metal and mono-, di- or triammonium salts, and glutamic acid diacetic acid, and its respective mono-, di-, tri- or tetraalkali metal and mono-, di-, tri- or tetraammonium salts,

(ii) in the range of from 1 percent by weight to 30 percent by weight based on the weight of component (A) of at least one homo- or copolymer of (meth)acrylic acid (B) that is either partially or fully neutralized, and

(iii) water,

said aqueous solution being stable for at least one week.

Complexing agent (A) is selected from methylglycine diacetic acid and its respective mono-, di-, or trialkali metal and mono-, di- or triammonium salts (in the following called alkali metal salt of methylglycine diacetic acid), and glutamic acid diacetic acid its respective mono-, di-, tri- or tetraalkali metal and mono-, di-, tri- or tetraammonium salts (in the following called alkali metal salt of glutamic acid diacetic acid).

In the context of the present invention, alkali metal salts of methylglycine diacetic acid are selected from lithium salts, potassium salts and preferably sodium salts of methylglycine diacetic acid. Methylglycine diacetic acid can be partially or preferably fully neutralized with the respective alkali. In a preferred embodiment, an average of from 2.7 to 3 COOH groups of MGDA is neutralized with alkali metal, preferably with sodium. In a particularly preferred embodiment, complexing agent (A) is the trisodium salt of MGDA.

Likewise, alkali metal salts of glutamic acid diacetic acid are selected from lithium salts, potassium salts and preferably sodium salts of glutamic acid diacetic acid. Glutamic acid diacetic acid can be partially or preferably fully neutralized with the respective alkali. In a preferred embodiment, an average of from 3.5 to 4 COOH groups of GLDA is neutralized with alkali metal, preferably with sodium. In a particularly preferred embodiment, complexing agent (A) is the tetrasodium salt of GLDA.

Complexing agent (A) is at least partially neutralized with alkali metal, more preferably with sodium or potassium, most preferred with sodium.

Complexing agent (A) can be selected from racemic mixtures of alkali metal salts of MGDA and of GLDA, and of the pure enantiomers such as alkali metal salts of L-MGDA, alkali metal salts of L-GLDA, alkali metal salts of D-MGDA and alkali metal salts of D-GLDA, and of enantiomerically enriched mixtures of isomers.

In one embodiment of the present invention, complexing agent (A) is selected from mixtures of L- and D- enantiomers of methyl glycine diacetic acid (MGDA) or its respective mono-, di- or trialkali metal or mono-, di- and triammonium salt or mixtures thereof and L- and D-enantiomers of glutamic acid diacetic acid (GLDA) or its respective mono-, di-, tri-, or tetraalkali metal or mono-, di-, tri- or tetraammonium salt or mixtures thereof, said mixtures containing predominantly the respective L-isomer with an enantiomeric excess (ee) in the range of from 10 to 95%.

In one embodiment of the present invention the complexing agent (A) is essentially L-glutamic acid diacetic acid that is at least partially neutralized with alkali metal.

In one embodiment of the present invention, aqueous solutions according to the invention contain in the range of from 45 to 60% by weight of complexing agent (A), preferably 45 to 55% by weight and even more preferably 47 to 52% by weight. In another very preferred embodiment, aqueous solutions according to the invention contain in the range of from 49 to 51% by weight of complexing agent (A).

In one embodiment of the present invention, aqueous solutions according to the invention contain in the range of from 45 to 60% by weight alkali metal salt of of methylglycine diacetic acid of complexing agent (A), preferably 45 to 55% by weight and even more preferably 47 to 52% by weight. In another very preferred embodiment, aqueous solutions according to the invention contain in the range of from 49 to 51% by weight alkali metal salt of of methylglycine diacetic acid of complexing agent (A).

In one embodiment of the present invention, aqueous solutions according to the invention contain in the range of from 45 to 60% by weight alkali metal salt of GLDA as complexing agent (A), preferably 45 to 55% by weight and even more preferably 47 to 52 by weight, most preferably 49 to 51% by weight alkali metal salt of GLDA as complexing agent (A).

In any way, minor amounts of complexing agent (A) may bear a cation other than alkali metal. It is thus possible that minor amounts, such as 0.01 to 5 mol-% of total complexing agent (A) bear alkali earth metal cations such as Mg²⁺ or Ca²+, or an Fe (II) or Fe (III) cation.

Aqueous solutions according to the invention further contain a polymer, hereinafter also being referred to as polymer (B), the amount is in the range of from 1 percent by weight to 30 percent by weight, preferably 2.5 percent by weight to 20 percent by weight, most preferred 5 percent by weight to 15 percent by weight based on the weight of component (A).

Polymer (B) is selected from homopolymers (B) of (meth)acrylic acid and of copolymers (B) of (meth)acrylic acid, preferably of acrylic acid, in each case partially or fully neutralized with alkali. In the context of the present invention, copolymers (B) are those in which at least 50 mol-% of the comonomers are (meth)acrylic acid, preferably at least 75 mol-%, even more preferably 80 to 99 mol-%.

Suitable comonomers for copolymers (B) are ethylenically unsaturated compounds, such as styrene, isobutene, ethylene, α-olefins such as propylene, 1-butylene, 1-hexene, and ethylenically unsaturated dicarboxylic acids and their alkali metal salty and anhydrides such as but not limited to maleic acid, fumaric acid, itaconic acid disodium maleate, disodium fumarate, itaconic anhydride, and especially maleic anhydride. Further examples of suitable comonomers are C₁-C₄alkyl esters of (meth)acrylic acid, for example methyl acrylate, methyl methacrylate, ethyl acrylate, ethyl methacrylate, n-butyl acrylate.

In one embodiment of the present invention, polymer (B) is selected from copolymers of (meth)acrylic acid and a comonomer bearing at least one sulfonic acid group per molecule. Comonomers bearing at least one sulfonic acid group per molecule may be incorporated into polymer (B) as free acid or least partially neutralized with alkali. Particularly preferred sulfonic -acid-group-containing comonomers are 1-acrylamido-1-propanesulfonic acid, 2-acrylamido-2-propanesulfonic acid, 2-acrylamido-2-methylpropanesulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as the sodium salts, potassium salts or ammonium salts thereof.

Copolymers (B) may be selected from random copolymers, alternating copolymers, block copolymer and graft copolymers, alternating copolymers and especially random copolymers being preferred.

Useful copolymers (B) are, for example, random copolymers of acrylic acid and methacrylic acid, random copolymers of acrylic acid and maleic anhydride, ternary random copolymers of acrylic acid, methacrylic acid and maleic anhydride, random or block copolymers of acrylic acid and styrene, random copolymers of acrylic acid and methyl acrylate. More preferred are homopolymers of methacrylic acid. Even more preferred are homopolymers of acrylic acid.

Polymer (B) may constitute straight-chain or branched molecules. Branching in this context will be when at least one repeating unit of such polymer (B) is not part of the main chain but forms a branch or part of a branch. Preferably, polymer (B) is not cross-linked.

In one embodiment of the present invention, polymer (B) has an average molecular weight M_{w} in the range of from 1,500 to 15,000 g/mol, more preferably of from 2,000 to 10,000 g/mol, and most preferably of from 2,000 to 5,000 g/mol, determined by gel permeation chromatography (GPC) and referring to the respective free acid.

In one embodiment of the present invention, polymer (B) is at least partially neutralized with alkali, for example with lithium or potassium or sodium or combinations of at least two of the forgoing, especially with sodium. Preferably in the range of from 10 to 100 mol-% of the carboxyl groups of polymer (B) are neutralized with alkali, especially with sodium. More preferably 50 to 100 mol-% of of the carboxyl groups of polymer (B) are neutralized with alkali, especially with sodium. Even more preferably 80 to 100 mol-% of of the carboxyl groups of polymer (B) are neutralized with alkali, especially with sodium. Most preferred is a fully neutralized polymer (B).

In one embodiment of the present invention, the polyacrylic acid (B) is at least partially neutralized with alkali metal, more preferred fully neutralized with alkali metal, most preferred with sodium, potassium or mixtures of sodium and potassium.

In one embodiment of the present invention, polymer (B) is selected from per-sodium salts of polyacrylic acid, thus, polyacrylic acid, fully neutralized with sodium.

In one embodiment of the present invention, polymer (B) is selected from a combination of at least one polyacrylic acid and at least one copolymer of (meth)acrylic acid and a comonomer bearing at least one sulfonic acid group per molecule, both polymers being fully neutralized with alkali.

In one embodiment of the present invention, polymer (B) is selected from per-sodium salts of polyacrylic acid with an average molecular weight M_{w} in the range of from 1,500 to 15,000 g/mol, more preferably of from 2,000 to 10,000 g/mol, and most preferably of from 2,000 to 5,000 g/mol, determined by gel permeation chromatography (GPC) and referring to the respective free acid.

To determine the stability of the aqueous solutions, stability was monitored using the daily stability check, for which 200 ml of the solution was placed in a sealed glass and stored at 23° C. and 60% relative humidity. Each day the aqueous solution was controlled optically by observing the samples by eyesight for formation of crystals. The day crystals where observed first was noted and the test ended. The storage stability of the solution reported as the number of days without crystals observed (i.e. one day less than the duration of the storage stability test).

In one embodiment of the present invention, aqueous solutions according the invention have a pH value measured as 1 weight-% aqueous solution in the range of from 9 to 14,preferably from 9.5 to 12.

In one embodiment of the present invention, aqueous solutions according to the present invention may contain at least one inorganic base, for example potassium hydroxide or preferably sodium hydroxide. Preferred is an amount of 0.1 to 20 mol-% of inorganic base, referring to the total of COOH groups in complexing agent (A) and polymer (B).

Aqueous solutions according the invention furthermore contain water.

In one embodiment of the present invention, in aqueous solutions according to the invention, the balance of complexing agent (A) and polymer (B), and, optionally, inorganic base, is water. In other embodiments, aqueous solutions according to the invention may contain one or more liquids or solids other than complexing agent (A) and polymer (B) and water.

Furthermore, inventive mixtures as well as inventive solutions may contain one or more inorganic non-basic salts such as—but not limited to—alkali metal halide or preferably alkali metal sulphate, especially potassium sulphate or even more preferably sodium sulphate. The content of inorganic non-basic salt may be in the range of from 0.10 to 1.5% by weight, referring to the respective inventive mixture or the solids content of the respective inventive solution. Even more preferably, inventive mixtures as well as inventive solutions do not contain significant amounts of inorganic non-basic salt, for example in the range of from 50 ppm to 0.05% by weight, referring to the respective inventive mixture or the solids content of the respective inventive solution. Even more preferably inventive mixtures contain 1 to 50 ppm by weight of sum of chloride and sulphate, referring to the respective inventive mixture. The contents of sulphate may be determined, for example, by gravimetry or by ion chromatography.

In one embodiment of the present invention, aqueous solutions according to the invention further comprise in the range of from 0.5 to 15% by weight, preferably 1 to 10% by weight, more preferred 2 to 5% by weight of at least one salt of at least one organic acid, hereinafter also referred to as salt (C).

In the context of the present invention, salt (C) is selected from the salts of mono- and dicarboxylic acids. Furthermore, salt (C) is different from both complexing agent (A) and polymer (B).

In a preferred embodiment of the present invention, salt (C) either not neutralized or partially neutralized or fully neutralized with alkali metal is selected from the group consisting of acetic acid, formic acid, citric acid, tartaric acid, lactic acid, maleic acid, fumaric acid, malic acid, or mixtures thereof. Preferred salt (C) is selected from the group consisting of citric acid, formic acid, acetic acid, or mixtures thereof. More preferred salt (C) is selected from the group consisting of formic acid, acetic acid, or mixtures thereof. Most preferred salt (C) is formic acid.

In one preferred embodiment of the present invention, salt (C) is an alkali metal salt of methyl sulfonic acid, preferably the potassium or sodium salt, more preferably the sodium salt.

In one embodiment of the present invention, aqueous solutions according to the present invention do not contain any surfactant. In the context of the present invention, “do not contain any surfactant” shall mean that the total content of surfactants is below 0.1% by weight of the respective aqueous solution.

In one embodiment of the present invention, complexing agent (A) may contain minor amounts of impurities stemming from its synthesis, such as lactic acid, alanine, propionic acid or the like. “Minor amounts” in this context refer to a total of 0.1 to 1% by weight, referring to complexing agent (A).

In one embodiment of the present invention, aqueous solutions according to the invention may have a dynamic viscosity in the range of from 55 to 1000 mPa·s, preferably of from 100 to 700 mPa·s, more preferred of from 150 to 400 mPas determined according to DIN 53018 at 25° C.

In one embodiment of the present invention, aqueous solutions according to the invention may have a color number according to Hazen in the range of from 15 to 400, preferably to 300, determined according to DIN EN1557 at 25° C.

A further aspect of the present invention is the use of an inventive mixture or an inventive solution for the manufacture of detergent compositions for cleaners. A further aspect is a process for manufacture of detergent compositions cleaners by using an inventive mixture or an inventive solution. Depending on whether a mixing in aqueous formulation or in dry matter is desired, and depending on whether a liquid or solid detergent composition is desired, an inventive aqueous solution or an inventive mixture of isomers can be used. Mixing can be performed by formulation steps known per se.

In particular when mixing is being carried out with an inventive solution for the production of a solid detergent composition for cleaners, such use is advantageous because it allows to add only reduced amounts of water to be removed later, and it allows for great flexibility because no additional ingredients such as polymer, surfactants or salts are present that otherwise reduce flexibility of the detergent manufacturer.

In one embodiment of the present invention, inventive aqueous solutions may be used as such for the manufacture of detergent compositions for cleaners. In other embodiments, inventive aqueous solutions may be used in fully or preferably partially neutralized form for the manufacture of detergent compositions for cleaners. In one embodiment, inventive aqueous solutions may be used in fully or preferably partially neutralized form for the manufacture of detergent compositions for cleaners, said neutralization being performed with an inorganic acid (mineral acid). Preferred inorganic acids are selected from H₂SO₄, HCl, and H₃PO₄. In other embodiments, inventive aqueous solutions may be used in fully or preferably partially neutralized form for the manufacture of detergent compositions for cleaners, said neutralization being performed with an organic acid. Preferred organic acids are selected from CH₃SO₃H, acetic acid, propionic acid, and citric acid.

In the context of the present invention, the term “detergent composition for cleaners” includes cleaners for industrial or institutional applications.

Another aspect of the present invention is thus the use of aqueous solutions according to the invention for cleaner compositions for industrial or institutional applications.

Another aspect of the present invention is a process for making aqueous solutions according to the invention, said process also being referred to as inventive process. The inventive process comprises the steps of

(i) providing an aqueous solution of complexing agent (A) with a solids content in the range of from 41 to 50 weight-%,

(ii) adding polymer (B) to said solution, followed by

(iii) removal of water to obtain a solution with a concentration of complexing agent (A) in the respective aqueous solution of from 45 to 60%.

This inventive process enables fast manufacture of highly concentrated solutions of complexing agent (A) in water, whereas dissolution of the final amount of complexing agent (A) in an aqueous solution containing already dissolved polymer (B) for stabilization of the resulting aqueous solution is very slow.

In one embodiment of the present invention, the mixing of complexing agent (A) with polymer (B) in water may be performed at a temperature in the range of from 30 to 85° C., preferably 25 to 50° C. In another embodiment of the present invention, mixing of complexing agent (A) with polymer (B) can be performed at ambient temperature or slightly elevated temperature, for example in the range of from 21 to 29° C. The inventive process can be performed at any pressure, for example at a pressure in the range of from 500 mbar to 25 bar. Normal pressure is preferred.

The inventive process can be performed in any type of vessel, for example in a stirred tank reactor or in a pipe with means for dosage of polymer (B), or in a beaker, flask or bottle.

Removal of water can be achieved, for example, with the help of membranes or by evaporation. Evaporation of water can be performed by distilling off water, with or without stirring, at normal pressure or pressure below normal pressure, for example at a temperature in the range of from 20 to 65° C.

The invention is further illustrated by the following working examples.

### Working Examples

Percentages refer to % by weight unless expressly noted otherwise.

The following substances were used:

Complexing agent A.1: Trisodium salt of MGDA, provided as 40% by weight aqueous solution, pH value: 13.

Polymer B.1: Homopolymer of acrylic acid, powder, 92% purity, neutralized with sodium hydroxide, weight average molar weight as determined by GPC is 4000 g/mol, the pH of a 1 weight-% aqueous solution is 8.

Comparative polymer B.2: Polycondensate of naphthalenesulfonic acid, powder, 95% purity, Na salt, the pH of a 1 weight-% aqueous solution is 10.

Formic acid, 100%, solid.

### Example 1

112.5 g complexing agent A.1 (40 wt.-% solution), 8.15 g polymer B.1 and 1.6 g formic acid were mixed at 23° C., a clear solution was obtained. 22.25 g of water was removed by distillation under vacuum.

The aqueous solution so obtained was clear. It had a dynamic viscosity of 345 mPas (measured with a Brookfield viscometer at 23° C., using spindle 31) and was stable in a sealed glass bottle at 23° C., 60% relative humidity for at least 5 weeks.

### Comparative Example 1

Example 1 was repeated, replacing polymer B.1 by comparative polymer B.2. The resulting solution turned opaque within 12 hours.

### Comparative Example 2

112.5 g complexing agent A.1 (40 wt.-% solution), 16.30 g polymer B.1 and 1.6 g formic acid were mixed at 23° C. 30.4 g of water was removed by distillation under vacuum.

The aqueous solution so obtained was instantaneously turbid.

1. An aqueous solution, comprising:
(i) 45 percent by weight to 60 percent by weight of at least one complexing agent (A) selected from the group consisting of methylglycine diacetic acid, mono-, di-, or trialkali metal and mono-, di- or triammonium salts of methylglycine diacetic acid, glutamic acid diacetic acid, and mono-, di-, tri- or tetraalkali metal and mono-, di-, tri- or tetraammonium salts of glutamic acid diacetic acid, based on a total weight of the aqueous solution;
(ii) from 1 percent by weight to 30 percent by weight of at least one homo- or copolymer of (meth)acrylic acid (B) that is either partially or fully neutralized, based on a total weight of the complexing agent (A); and
(iii) water,
wherein the aqueous solution is stable for at least one week.

2. The aqueous solution according to claim 1, wherein the complexing agent (A) is a mixture of L- and D-enantiomers of methyl glycine diacetic acid and its respective mono-, di-, or trialkali metal and mono-, di- or triammonium salts, said mixture containing predominantely the respective L-isomer with an enantiomeric excess (ee) ranging from 10 to 75%.

3. The aqueous solution according to claim 1, wherein complexing agent (A) consists essentially of L-glutamic acid diacetic acid that is at least partially neutralized with alkali metal.

4. The aqueous solution according to claim 1, comprising from 45 to 55 percent by weight of the complexing agent (A), based on the total weight of the aqueous solution.

5. The aqueous solution according to claim 1, wherein the complexing agent (A) is at least partially neutralized with alkali metal.

6. The aqueous solution according to claim 1, comprising 2.5 percent by weight to 20 percent by weight of the homo- or copolymer of (meth)acrylic acid (B), based on the total weight of the complexing agent (A).

7. The aqueous solution according to claim 1, wherein 10 to 100 mol-% of carboxylic groups of the homo- or copolymer of (meth)acrylic (B) are neutralized with alkali metal.

8. The aqueous solution according to claim 1, wherein the homo- or copolymer of (meth)acrylic acid (B) has an average weight molecular weight of from 1500 to 15000 g/mol.

9. The aqueous solution according to claim 1, further comprising:
from 0.5 percent by weight to 15 percent by weight of an organic acid salt (C), based on the total weight of the aqueous solution.

10. The aqueous solution according to claim 9, wherein the organic acid salt (C) is partially neutralized or fully neutralized with an alkali metal selected from the group consisting of citric acid, formic acid, and acetic acid.

11. A process for making the aqueous solution of claim 1, the process comprising adding the homo- or copolymer of (meth)acrylic acid (B) to an aqueous solution of the complexing agent (A) with a solids content in the range of from 41 to 50 weight-%, followed by removing water to obtain the aqueous solution comprising the 45 percent by weight to 60 percent by weight of the complexing agent (A).

12. A cleaner composition, comprising the aqueous solution of claim 1.
